(19) United States
(12) Patent Application Publication
(10) Pub. No.: US 2007/0117640 A1
(43) Pub. Date: May 24, 2007

(54) Composite clutch shaft assembly

(76) Inventor: Raymond J. Haka, Brighton, MI (US)

Correspondence Address: GENERAL MOTORS CORPORATION;LEGAL STAFF, MAIL CODE 482-C23-B21, P O BOX 300, DETROIT, MI, 48265-3000, US

(21) Appl. No.: 11/284,252

(22) Filed: Nov. 21, 2005

(51) Int. Cl. F16C 3/00

(52) U.S. Cl. 464/183

(57) ABSTRACT

A composite clutch shaft assembly has an annular hub with a shaft extending therefrom. The shaft has a generally tubular outer portion and a core portion. The core portion has higher internal damping than the outer portion, thereby improving the vibration and noise damping characteristics of the clutch shaft while having little or no effect on the external dimensions of the clutch shaft.

### TECHNICAL FIELD

The present invention relates to torque transferring devices used within vehicle transmissions, and, more particularly, to a composite clutch shaft assembly.

### BACKGROUND OF THE INVENTION

Clutch shafts for use in vehicle transmissions are well known in the art. Generally, a shaft extends from a clutch hub and supports a gear. A clutch selectively engages teeth formed within the clutch hub to selectively transfer torque between the clutch and the gear. The vehicle transmission may experience an audible noise or “squawk” when the clutch is applied or released at elevated temperatures. This “squawk” may be a result of instability of the clutch hub and shaft system. The spring rate and inertia of the system may be such that the shaft behaves as a one degree of freedom system, with the clutch hub and clutch plates acting as the inertia and the output end of the shaft acting as the ground.

The hub is subject to the friction force of the slipping clutch, which can exhibit a negative coefficient of friction versus slip speed characteristic when the clutch becomes hot, aged, or subject to high unit loading. This negative friction slope emulates negative damping, which may cause the one degree of freedom system to become unstable if the negative slope and the positive internal damping of the shaft sum to a negative value. In such situations, the oscillation of the hub (inertia) across the shaft (spring) will increase exponentially until a non-linearity is encountered. Such non-linearities may be that the clutch plate splines no longer contact the hub or that the rotational velocity of the clutch moves the friction characteristics out of the negative slip zone. Engineers have improved “squawk” characteristics in the past by increasing the diameter of the shaft, increasing the inertia of the hub, increasing heat extraction from the clutch pack, increasing clutch surface area, and/or the addition of a damper. The damper may be either a coulomb type or a tuned mass damper.

### SUMMARY OF THE INVENTION

Provided is a composite clutch shaft having a hub and a shaft extending from the hub. The shaft has a core portion disposed within a generally tubular outer portion. The core portion has a higher internal damping characteristic than the outer portion. The core portion may be either solid or hollow. Additionally the core portion may be formed from grey iron and press fit into the outer portion which may be formed from steel. The core portion may extend substantially the entire length of the shaft.

Also provided is a composite clutch shaft including a hub having a shaft extending therefrom. The shaft is formed from a heat treatable material and the shaft has a heat treated outer portion and a non-heat treated core portion. The non-heat treated core portion has a higher internal damping characteristic than the heat treated outer portion.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a sectional perspective view of a composite clutch shaft assembly broken away to show a core portion within an outer portion of a shaft portion according to the present invention;

FIG. 2 is a side view of the composite clutch shaft assembly of FIG. 1, showing the core portion in phantom;

FIG. 3a is a schematic cross sectional view of one embodiment of the shaft portion of the composite clutch shaft assembly taken along line A-A of FIG. 2;

FIG. 3b is a schematic cross sectional view of a second embodiment of the shaft portion of the composite clutch shaft assembly also taken along line A-A of FIG. 2;

FIG. 4a is a schematic cross sectional view of a third embodiment of the shaft portion of the composite clutch shaft assembly also taken along line A-A of FIG. 2; and

FIG. 4b is a schematic cross sectional view of a fourth embodiment of the shaft portion of the composite clutch shaft assembly also taken along line A-A of FIG. 2.

### DESCRIPTION OF THE PREFERRED EMBODIMENTS

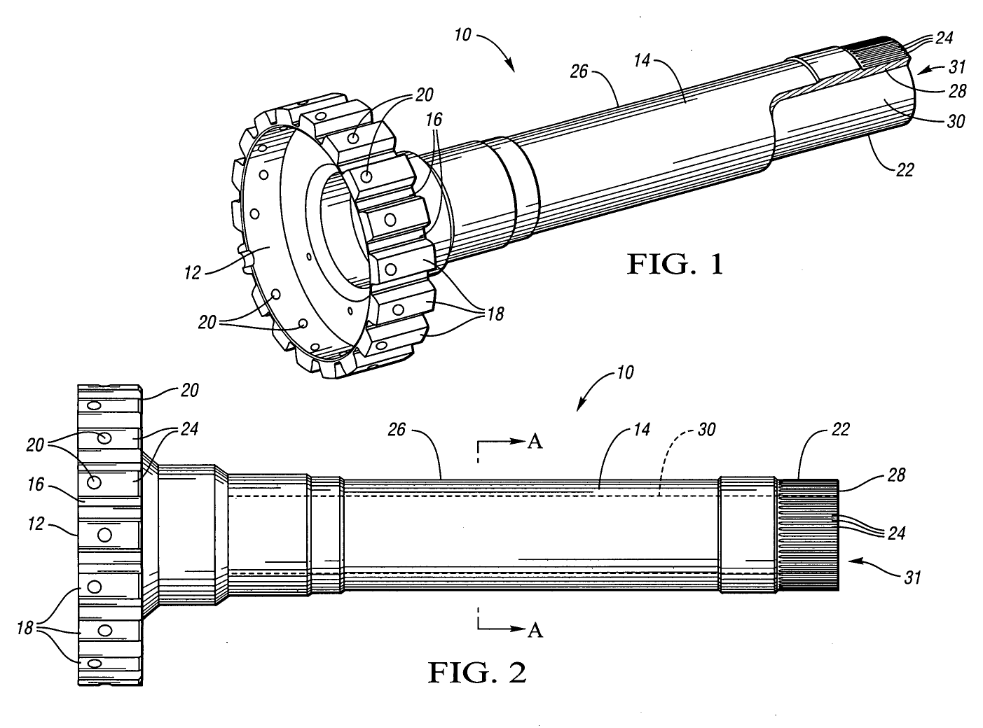

Referring to FIGS. 1 and 2, a composite clutch shaft or composite clutch shaft assembly according to the present invention is shown at 10. The composite clutch shaft assembly 10 comprises an annular hub or hub portion 12 with a shaft or shaft portion 14 extending therefrom. The hub 12 and the shaft 14 may be formed integrally as a single piece or may be two pieces joined together. In the preferred embodiments, the shaft assembly 10 is a fourth clutch shaft for a vehicle transmission. As such, the hub 12 is configured to be matable with a clutch (not shown), while the shaft 14 is configured to support a gear (not shown). However, it should be appreciated that the present invention may be used to transfer torque in a variety of applications within the inventive concept.

The hub 12 includes a circumferential wall 16 having a plurality of teeth 18 protruding radially therefrom. The plurality of teeth 18 preferably extend about the entire perimeter of the circumferential wall 16. Lubricant openings 20 extend through at least some of the plurality of teeth 18 to allow lubricant to flow into and out of the composite clutch shaft 10. The hub 12 is preferably configured to engage the clutch within the vehicle transmission. When the clutch is applied, splined clutch plates transfer torque from the clutch to the hub 12 for substantially unitary rotation therewith.

The shaft 14 extends from the hub 12 to a splined end portion 22. Splines 24 are formed on an outer surface 26 of the shaft 14 at the splined end portion 22. In the preferred embodiment, the splines 24 extend around the entire outer surface 26 of the shaft 14. The splines 24 are preferably configured to support a gear. Preferably, the splines 24 are induction hardened following formation, thereby reducing spline degradation caused by the gear.

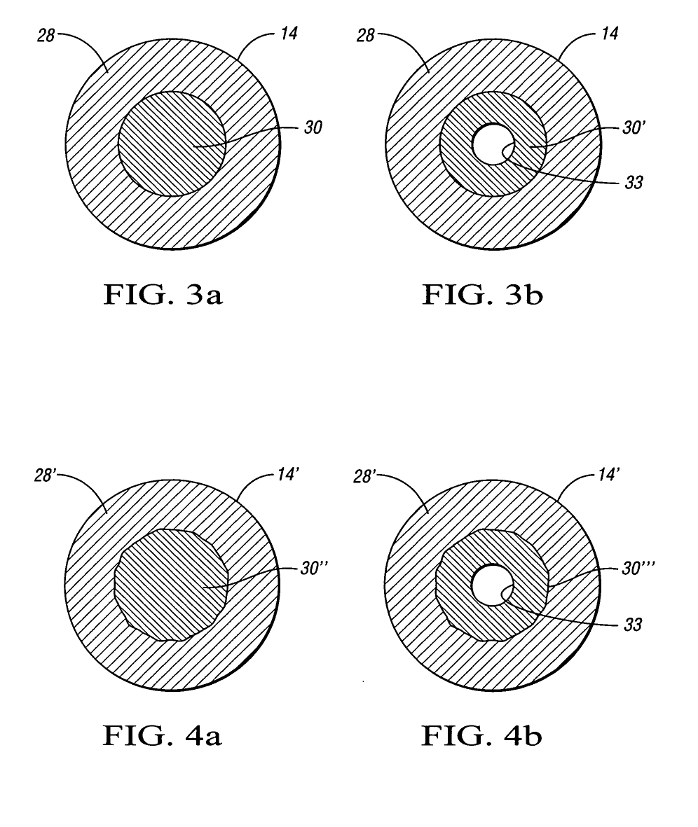

With reference to FIG. 3a, the shaft 14 of the present invention includes a generally tubular outer portion 28 having an inner core portion 30 disposed therein. In the preferred embodiment, the core portion 30 will extend substantially the length of the shaft 14 from end 31, as shown in phantom in FIG. 2. Those skilled in the art will recognize that the core portion 30 may extend for less than the length of the shaft 14 as design constraints of the composite clutch shaft 10 dictate. Preferably, the core portion 30 is press fit into the tubular outer portion 28; however, those skilled in the art will recognize other methods operable to retain the core portion 30 relative to the outer portion 28, such as bonding or staking. FIG. 3a illustrates one embodiment of the present invention in which a cross sectional view of the shaft 14 illustrates the outer portion 28 and the inner core portion 30. The inner core portion 30 may be solid or hollow. FIG. 3b illustrates a second embodiment of the present invention in which a cross sectional view of the shaft 14 illustrates a core portion 30′ defining a hollow center 33.

An exemplary embodiment of the shaft 14 in FIGS. 3a and 3b would be to form the core portions 30 and 30′ from a stiff material with a high internal damping characteristic, such as grey iron. Grey iron core portions, such as 30 and 30′, would be press fit into a steel outer portion, such as 28, having a known or predetermined internal damping characteristic. The grey iron has approximately half the stiffness of steel, but has nearly eighty times the internal damping of quenched and tempered high carbon steel having a martensite microstructure. The damping characteristic of the shaft 14 is thus improved compared to hollow or solid shafts formed from a single material. This increased damping characteristic is achieved without changing the exterior dimensions of the shaft 14 or significantly increasing stresses within the steel constituting the outer portion 28.

A third and fourth embodiment of the present invention is shown respectively in FIG. 4a and 4b. In FIG. 4a there is shown a cross section of a shaft 14′. In this embodiment, the shaft 14′ is formed from a heat treatable material, such as steel. In this embodiment, the outer portion 28′ is formed by heat treating the shaft 14′ sufficiently to a predetermined depth while leaving core portion 30″ unaffected. By doing so, the core portion 30″ will maintain high internal damping compared to the outer portion 28′. FIG. 4b is a cross sectional view of the shaft 14′ illustrating a core portion 30′″ defining a hollow center 33, similar to that shown in FIG. 3b.

Exemplary of the embodiments shown in FIGS. 4a and 4b, the shaft 14′ may be made of steel. The shaft 14′ may be sufficiently heat treated to form a martensite microstructure in the outer portion 28′ while the core portions 30″ and 30′″ will maintain a ferrite microstructure, which has approximately eight times the internal damping of steel with a martensite microstructure. The shaft 14′ will have a greater damping ability than a shaft having a martensite microstructure for both the outer portion 28′ and the core portions 30″ and 30′″.

Those skilled in the art will recognize that the relative radial thicknesses of the outer portions 28, 28′ and the core portions 30, 30′, 30″, and 30′″ will be dictated by engineering constraints such as torsional loading on the shaft 14, 14′. The composite clutch shaft 10 of the present invention may reduce unwanted noise and vibration within the power transmission by increasing the damping effectiveness of the shaft 14 and 14′.

While the best modes for carrying out the invention have been described in detail, it is to be understood that the terminology used is intended to be in the nature of words and description rather than of limitation. Those familiar with the art to which this invention relates will recognize that many modifications of the present invention are possible in light of the above teachings. It is, therefore, to be understood that within the scope of the appended claims, the invention may be practiced in a substantially equivalent way other than as specifically described herein.

1. A composite clutch shaft comprising:
a hub;
a shaft extending from said hub;
wherein said shaft has a core portion disposed within a generally tubular outer portion, said tubular outer portion being formed from a first material having a predetermined internal damping characteristic; and
wherein said core portion is formed from a second material having a higher internal damping characteristic than said first material.

2. The composite clutch shaft of claim 1, wherein said core portion is solid.

3. The composite clutch shaft of claim 1, wherein said core portion is hollow.

4. The composite clutch shaft of claim 1, wherein said second material is grey iron, and said first material is steel.

5. The composite clutch shaft of claim 1, wherein said core portion is press fit into said generally tubular outer portion.

6. The composite clutch shaft of claim 1, wherein said core portion extends for substantially the entire length of said shaft.

7. The composite clutch shaft of claim 1, wherein said second material has an internal damping characteristic significantly greater than the internal damping characteristic of said first material.

8. A composite clutch shaft comprising:
a hub having a shaft extending therefrom;
wherein said shaft is formed from a heat treatable material;
wherein said shaft has a heat treated outer portion, which has a predetermined internal damping characteristic, and a non-heat treated core portion; and
wherein said non-heat treated core portion has a higher internal damping characteristic than the heat treated outer portion.

9. The composite clutch shaft of claim 8, wherein said shaft is formed from steel, said outer portion being heat treated to form a martensite microstructure and said core portion is ferrite steel.

10. The composite clutch shaft of claim 8, wherein said shaft is solid.

11. The composite clutch shaft of claim 8, wherein said shaft is hollow.

12. The composite clutch shaft of claim 8, wherein said shaft is cylindrical and heat treated to a depth of approximately half the radial thickness of said shaft.

13. The composite clutch shaft of claim 8, wherein said non-heat treated core portion has an internal damping characteristic significantly greater than the internal damping characteristic of said heat treated outer portion.

14. A composite clutch shaft comprising:
a hub;
a shaft extending from said hub;
wherein said shaft has a core portion disposed within a generally tubular outer portion, said generally tubular outer portion being formed from a first material having a predetermined internal damping characteristic;
wherein said core portion is formed from a second material having a higher internal damping characteristic than said first material; and
wherein said core portion is formed form grey iron, and said outer portion is formed from steel.

15. The composite clutch shaft of claim 14, wherein said shaft is solid.

16. The composite clutch shaft of claim 14, wherein said shaft is hollow.

17. The composite clutch shaft of claim 14, wherein said core portion is press fit into said generally cylindrical outer portion.

18. The composite clutch shaft of claim 14, wherein said core portion extends for substantially the entire length of said shaft.

19. The composite clutch shaft of claim 14, wherein said second material has an internal damping characteristic significantly greater than the internal damping characteristic of said first material.
